(19) United States
(12) Patent Application Publication
(10) Pub. No.: US 2015/0001413 A1
(43) Pub. Date: Jan. 1, 2015

(54) DEVICE FOR DETECTING NEUTRONS

(71) Applicant: COMMISSARIAT A L'ENERGIE ATOMIQUE ET AUX ENERGIES ALTERNATIVES, Paris (FR)

(72) Inventors: Ioannis GIOMATARIS, Versailles (FR); Gilles GERBIER, Massy (FR); Thomas PAPAEVANGELOU, Igny (FR); Ilias SAVVIDIS, Kassandra (GR)

(21) Appl. No.: 14/321,364

(22) Filed: Jul. 1, 2014

(30) Foreign Application Priority Data
Jul. 1, 2013 (FR) 1356374

(51) Int. Cl. G01T 3/00

(52) U.S. Cl. CPC G01T 3/008
USPC 250/391; 250/390.01

(57) ABSTRACT

A spherical device for detecting neutrons includes a sphere-shaped cathode and a ball-shaped anode. The cathode forms an enclosure filled with an ionising gas. The ionising gas is pure nitrogen. The ionising gas can also be mixed with a quencher. In this case, the quencher may be ethane.

### CROSS-REFERENCE TO RELATED APPLICATIONS

This application claims priority to French Patent Application No. 1356374, filed Jul. 1, 2013, the entire content of which is incorporated herein by reference in its entirety.

### FIELD

The present invention relates to a device for detecting neutrons.

### BACKGROUND

A spherical neutron detector generally includes a first electrode which forms a hollow sphere-shaped enclosure. This first electrode contains a second ball-shaped electrode which is held in the centre of the first electrode thanks to a holding rod. The first electrode is connected to the ground, whereas the second electrode is brought up to a high potential. The hollow sphere which forms the first electrode is filled with an ionising gas. The detection of neutrons is made by ionising gas particles which then produce a positively charged ion and a negatively charged electron. The electric field applied between the electrodes enables:
the electrons created by ionising the gas to be deviated up to the ball by creating a radial field and
an avalanche to be produced in the proximity of the ball to amplify the signal.

In prior art, the ionising gas used is most often helium ³He. In this case, the neutrons are detected via the following reaction:

³He+n−>H+³H+Q

with

Q=764 keV

Such a helium detector essentially enables thermal neutrons to be detected, that is neutrons the energy of which is lower than 100 meV but does not have a high efficiency for fast neutrons, that is neutrons the energy of which is higher than 1 MeV.

In prior art, the ionising gas could also be boron trifluoride BF₃. In this case, the neutrons are detected via the following reaction:

¹⁰B+n−>⁷Li+alpha+Q avec Q=2.41 MeV.

However, helium and boron trifluoride are either very expensive, or toxic.

### SUMMARY

An aspect of the invention aims at overcoming the drawbacks of the state of the art by providing a neutron detector which both enables thermal neutrons and fast neutrons to be detected and which is cheaper and less dangerous than detectors of prior art.

To do this, an embodiment of the invention uses nitrogen N₂ as the ionising gas.

More precisely, a first aspect of the invention relates to a device for detecting neutrons comprising a first electrode forming a spherical enclosure containing a second ball-shaped electrode, the enclosure being filled with a gas, the gas comprising at least 20% nitrogen, beneficially 50% and more beneficially 90% nitrogen.

Thus, an embodiment of the invention suggests the use of nitrogen as the ionising gas. Indeed, the inventors have surprisingly found that nitrogen is very efficient as an ionising gas. However, in prior art, there was a negative prejudice against nitrogen as that ionising gas because it is difficult to trigger an avalanche in pure nitrogen. However, having a spherical detector enables sufficiently high electric fields to be applied in nitrogen to trigger an avalanche therein.

The detecting device according to the invention can also include one or more of the characteristics hereinafter taken independently or according to all technically possible combinations.

According to a first embodiment, the gas contained in the enclosure formed by the first electrode is pure nitrogen. This embodiment is simple, cheap and it allows a satisfactory gain.

According to a second embodiment, the gas contained in the enclosure formed by the first electrode is a mixture of:
the ionising gas which is nitrogen, and
an additional gas called “quencher”. The role of the quencher is to absorb the possible photons created upon exciting the gas molecules.

Beneficially, the quencher is a hydrocarbon, beneficially with fewer than 10 carbon atoms, like CH₄, C₂H₆, C₄H₁₀ . . . , and more beneficially ethane. This addition of a few percent of ethane in nitrogen enables the detector gain to be improved. However, such an addition is not beneficial for detecting neutron capture, because the light atoms as hydrogen produce noise signals by neutron-hydrogen elastic collision.

Thus, according to different embodiments, the gas contained in the enclosure can contain between 95% and 100% N₂ and between 0% and 6% hydrocarbon, beneficially C₂H₆.

Beneficially, the gas contained in the enclosure is at a pressure equal to or higher than 500 mbar in order to have a better efficiency for low neutron flows.

Further, in an embodiment, the gas pressure in the enclosure is beneficially lower than 5 bar. Since the increase in pressure implies an increase in the voltage to keep an equivalent performance, too strong a pressure could imply breakdown problems.

The detecting device beneficially includes a first connecting device constructed and arranged to connect the first electrode to the ground. The first electrode thus forms a cathode.

The detecting device also beneficially includes a holding rod able to hold the second electrode in the centre of the spherical enclosure formed by the first electrode. The holding rod may also be connected to the ground.

The detecting device also beneficially includes a powering device constructed and arranged to apply a potential to the second electrode. The second electrode thus forms an anode. The powering device can be connected to the second electrode via second a connecting device. The second connecting device is beneficially located inside the holding rod.

Beneficially, the second electrode has a diameter lower than 1 cm, beneficially lower than 5 mm, and further beneficially lower than 1 mm. Indeed, the lower the diameter of the second electrode, the higher electric fields can be obtained in the spherical enclosure, and thus the more possible to trigger avalanches in nitrogen.

Beneficially, the first electrode has a diameter higher than 10 cm. Indeed, the larger the enclosure, the more limited the edge effects and the greater the detection efficiency; but if the pressure can be increased, the volume can remain small. Besides, depending on the intensity of the neutron flow to be detected, the sphere size will be adapted and will be for example all the greater that the flow will be low in order to increase the interaction probabilities.

The detecting device can be used to detect thermal neutrons, that is neutrons the energy of which is lower than 100 meV. The thermal neutrons interact with nitrogen according to the following reaction:

¹⁴N+n−>¹⁴C+p+Q

with

Q=6.25.87 keV (n−p reaction)

The detecting device can also be used to detect fast neutrons, that is neutrons the energy of which is higher than 1 MeV. The fast neutrons interact with nitrogen according to the reaction described in the case of thermal neutrons, but also according to the following reaction:

¹⁴N+n−>¹¹B+α−Q

with

Q=158 keV (n−α reaction)

An aspect of the invention also relates to the use of the detecting device for detecting which n−p or n−α reaction occurs. For this, it is possible to measure the signal rise time as a function of the incident neutral energy.

### BRIEF DESCRIPTION OF THE FIGURES

Further characteristics and benefits of the invention will become clear upon reading the detailed description that follows, in reference to the appended figures, which illustrate:

FIG. 1, a schematic cross section view of a detecting device according to an embodiment of the invention;

FIG. 2, the cross section of fast neutrons towards nitrogen as a function of the energy of fast neutrons;

FIG. 3a, the signal rise time measured by a device according to an embodiment of the invention when it receives a flow of neutrons from a ²⁵²Cf source as a function of the amplitude of this neutron flow;

FIG. 3b, the amplitude spectrum in analogue-digital converters connected to a detecting device according to an embodiment of the invention filled with pure nitrogen at 500 mbar which is subjected to a flow of neutrons from a ²⁵²Cf source;

FIG. 4a, the signal rise time as a function of the amplitude of a flow of atmospheric neutrons measured in a device according to an embodiment of the invention containing pure nitrogen at 500 mbar;

FIG. 4b, the amplitude spectrum in analogue-digital converters connected to a detecting device according to an embodiment of the invention filled with pure nitrogen at 500 mbar which is subjected to atmospheric neutrons;

FIG. 5, a comparison of the cross sections of the reactions ³He(n, p)³H, ¹⁰B(n, α)⁷Li, ¹⁴N(n, p)¹⁴C and ¹⁴N(n, α)¹¹B for fast neutrons the energy of which is lower than 20 MeV;

FIG. 6, a view of the projection onto the radius of the first electrode of the energies deposited by all the neutron capture products.

For the sake of clarity, identical or similar elements are marked with identical reference signs throughout the figures.

### DETAILED DESCRIPTION

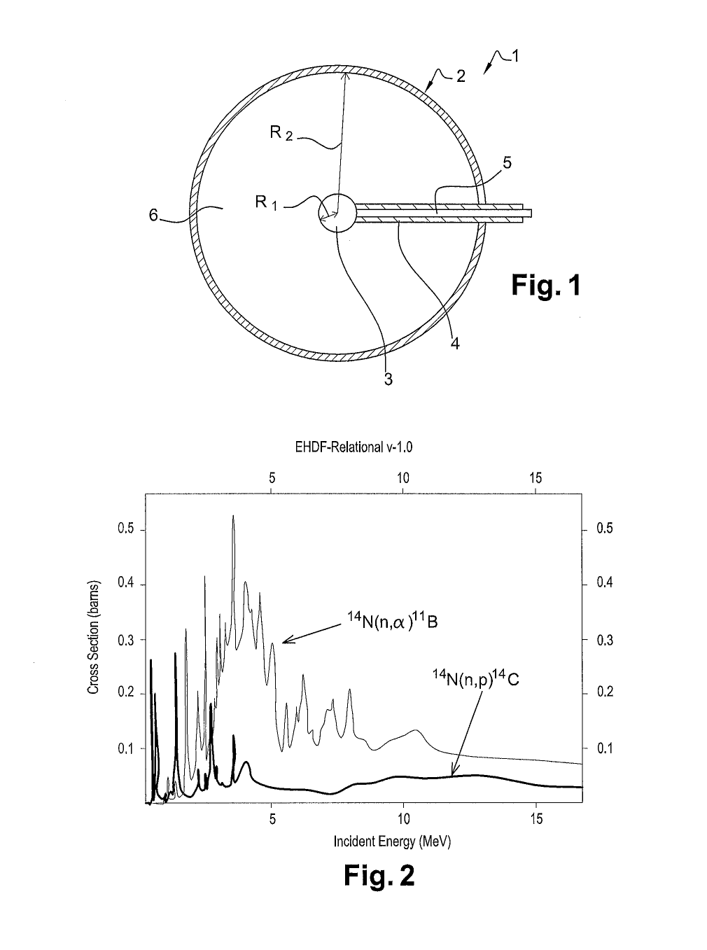

FIG. 1 represents a detecting device 1 according to an embodiment of the invention. This detecting device 1 includes a first electrode 2 forming a sphere-shaped enclosure 6. The first electrode 2 is connected to the ground so as to form a cathode. The first electrode 2 is beneficially formed by a copper sphere. It has beneficially a diameter higher than 1 m, Thus, in this embodiment, the first electrode has a diameter of 1.3 m. The copper wall forming the first electrode has a thickness of 6 mm.

The detecting device also includes a second electrode 3 formed by a ball. This ball is made of stainless steel. In this embodiment, the ball has a diameter of 14 cm.

The second electrode 3 is held in the centre of the first electrode 2 thanks to a holding rod 4. The holding rod 4 is also made of stainless steel. The external surface of the holding rod 4 is also connected to the ground. Further, the holding rod 4 is hollow, and connecting device 5 for placing the second electrode to the desired potential pass through it. The second electrode 3 is thus powered so as to form an anode. The connecting device 5 enables the electric field applied in the enclosure 6 to be controlled by controlling the potential of the second electrode.

Upon starting the detecting device according to the embodiment of the invention, the enclosure 6 formed by the first electrode is pumped, so as to reach a satisfactory vacuum. The vacuum reached can thus be up to 10⁻⁸ mbar. The enclosure 6 is then filled, with a gas at a pressure ranging from 500 mbar to 5 bar. A gas evolution at 10⁻⁹ mbar/s is required for the amplification stability because the presence of oxygen in the enclosure modifies the detector characteristics. The gas injected into the enclosure includes an ionising gas and it can also include a quencher. The ionising gas is nitrogen. The quencher, when present, is a hydrocarbon, beneficially with fewer than 10 carbon atoms, as CH₄, C₂H₆, C₄H₁₀ . . . , and more beneficially ethane. Thus, according to different embodiments, the gas injected in the enclosure 6 can be pure nitrogen (e.g. with a degree of purity greater than 99.999%) or even a mixture of nitrogen and hydrocarbons.

When the detector is operating, an electric field is applied between the first electrode and the second electrode. This electric field is controlled by s controlling the potential of the second electrode, whereas the first electrode is connected to the ground.

When neutrons penetrate the enclosure 6, they withdraw electrons from the nitrogen atoms and produce either protons, or a particles, which by slowing down in the gas, produce positively charged ions and negatively charged electrons. The electrons are attracted by the first electrode. An avalanche occurs at a few millimetres from the second electrode and the positive ions which go to the first electrode induce a pulse in the charge preamplifier. As the avalanche occurs close to the second electrode and the electrons are attracted by the first electrode, the positive ions travel over a great distance. Consequently, the pulse induced in the preamplifier is mainly due to the ion movement. The electrons produced during the avalanche have a negligible contribution to the signal.

This phenomenon can enable thermal neutrons and fast neutrons to be detected.

The cross section of the thermal neutrons, that is the neutrons the energy of which is lower than 100 meV, is 1.83 barns. When thermal neutrons penetrate the enclosure 6, they react with nitrogen ¹⁴N nuclei according to the following reaction:

¹⁴N+n−>¹⁴C+p+Q

with

Q=625.87 keV (n−p reaction)

The energy Q of the reaction is shared between ¹⁴C and the proton p. Thus, the carbon atom ¹⁴C is provided with an energy E_{c}=41.72 keV, whereas the proton is provided with an energy Eₚ=684.15 keV. Because of the energy and the travel of the protons in the enclosure gas, the signal obtained with the detector 1 is essentially due to the protons, especially as to the signal rise time and width.

The detector 1 can also enable fast neutrons to be detected, that is neutrons the energy of which is higher than 1 MeV. The cross section of the fast neutrons in nitrogen is represented in FIG. 2. As can be seen in FIG. 2, the fast neutrons also react with nitrogen nuclei according to the reaction ¹⁴H(n, p)¹⁴C:

¹⁴N+n−>¹⁴C+p+Q

with

Q=625.87 keV (¹⁴N(n, p)¹⁴C curve)

However, as can be seen in FIG. 2, the fast neutrons the energy of which is higher than 2 MeV mainly react with the nitrogen nuclei according to the reaction ¹⁴N(n, α)¹¹B:

¹⁴N+n−>¹¹B+α−Q

with

Q=158 keV (¹⁴N(n, α)¹¹B curve)

For some energies, the neutrons will be detected thanks to both reactions, which can induce some confusion in measuring the incident energy of the neutrons. This confusion is not an issue for high energies where its effect is strongly reduced. Beside, for medium energies, it is possible to discriminate both reactions by measuring the signal rise time, as a function of the incident neutron energy. FIG. 6 represents a projection onto the radius of the first electrode of energies deposited by all the neutron capture products. FIG. 6 corresponds to a simulation of a flat distribution of neutrons having an energy up to 20 MeV which passes through a device according to an embodiment of the invention. This device includes a first electrode having a radius of 65 cm filled with pure nitrogen at a pressure of 400 mbar. This projection, which reflects the rise time of the signal measured, is presented as a function of the neutron energy: zone A corresponds to the a particles, zone B corresponds to the protons. As represented in this figure, the projection length is systematically much higher for protons produced by the n−p interaction. This allows a good discrimination of the products obtained as a result of the interaction of the gas with the neutrons and thus a better assessment of the neutron flow as a function of the energy.

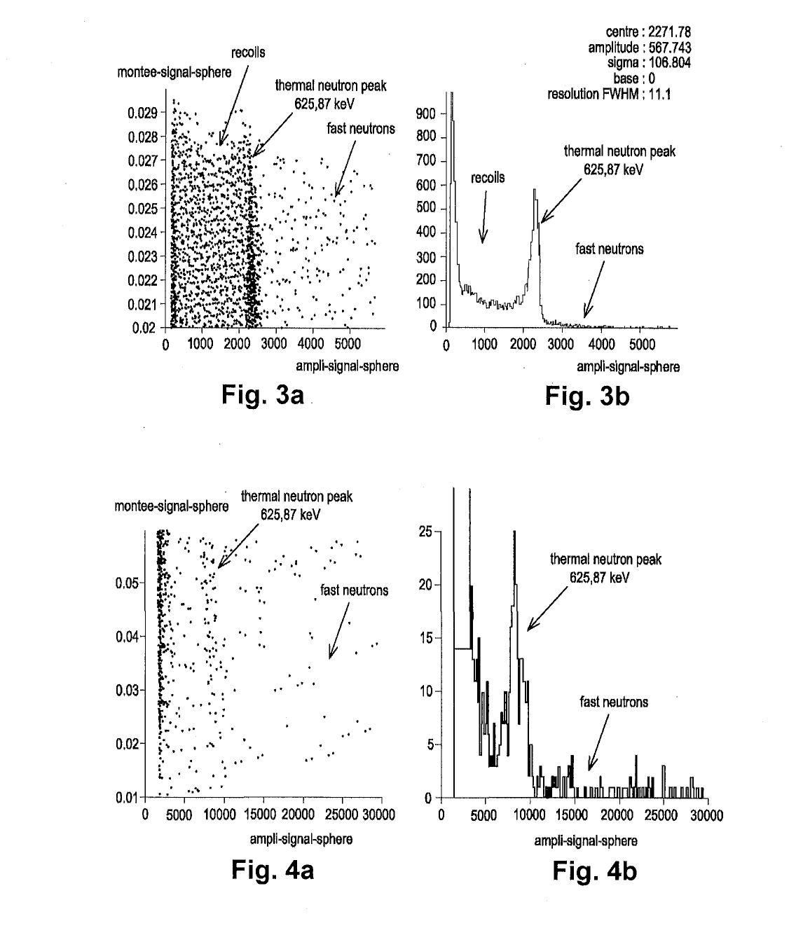

FIGS. 3a and 3b represent the results obtained with a device analogous to that of FIG. 1 the enclosure 6 of which is filled with a mixture of N₂ at 200 mbar and C₂H₆ at 10 mbar, irradiated by a ²⁵²Cf source. FIG. 3a represents the signal rise time as a function of the amplitude and FIG. 3b represents the amplitude spectrum in analogue-digital converters. The signal corresponding to the thermal neutrons forms a peak at 625.87 keV. This peak is only due to the reaction ¹⁴N(n, p)¹⁴C. This peak is well separated from the signal part (called “recoil” in the figures) which corresponds to the particle recoil and to the cosmic radiuses, which enables the flow of thermal neutrons to be easily calculated. The signal due to the fast neutrons is designated in the figures by “fast neutrons”. This signal is due to both reactions (n, p) and (n, α). As shown in FIGS. 3a and 3b, the nucleus recoil produced by fast neutrons produces little energy and a low signal rise time.

The device for detecting neutrons according to an embodiment of the invention can also enable atmospheric neutrons to be detected. For this, a detector similar to that of FIG. 1 but filled with pure nitrogen at a pressure of 500 mbar has been used. The results obtained after 15 acquisition hours are shown in FIGS. 4a and 4b. As can be seen in these figures, the signal corresponding to the thermal neutrons (thermal neutrons peak) clearly appears in the figures, wherein the signal corresponding to the fast neutrons is more diffuse.

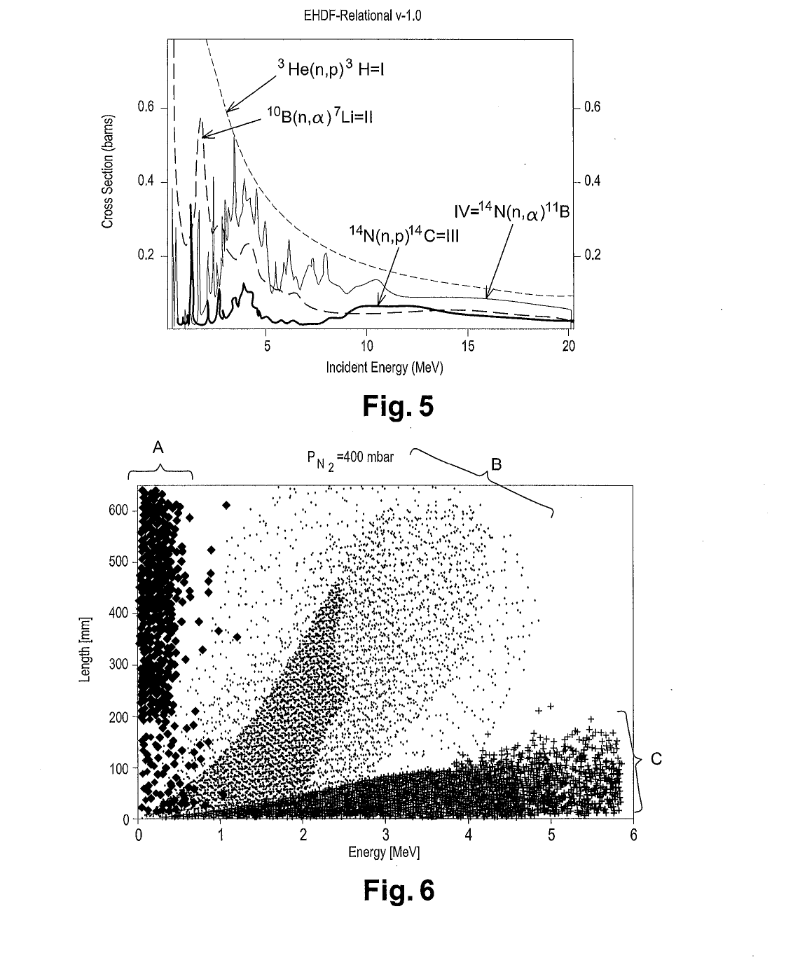

FIG. 5 compares the results obtained with:
I—A cylindrical detector of prior art filled with ³He wherein the neutrons are detected via the ³He(n, p)³H reaction
II—A cylindrical detector of prior art filled with ¹⁰BF₃ wherein the neutrons are detected via the ¹⁰B(n, a)⁷Li reaction;
III—A spherical detector according to an embodiment filled with pure N₂ at 500 mbar wherein the neutrons are detected via the ¹⁴(n, p)¹⁴C reaction;
IV—A spherical detector according to an embodiment filled with pure N₂ at 500 bar wherein the neutrons are detected via the ¹⁴N(n, α)¹¹B reaction.

As represented in FIG. 5, for thermal neutrons, N₂ has a lower cross section than ³He and BF₃ but this drawback can be compensated for by injecting more nitrogen atoms into the enclosure. Besides, for the fast neutrons, N₂ has a cross section equivalent to that of ³He and BF₃.

The use of nitrogen as an ionising gas can thus enable to have a cheaper and less toxic gas than gases used in prior art while having a performance for the detector equivalent to that of detectors of prior art.

It will be appreciated that the invention is not restricted to the embodiments described in reference to the figures and alternatives could be contemplated without departing from the scope of the invention. For example, the dimensions given in the exemplary embodiments for the electrodes could be changed, as well as the constituent materials of the electrodes and the holding rod.

1. A device for detecting neutrons comprising a first electrode forming a spherical enclosure containing a second ball-shaped electrode, the spherical enclosure being filled with a gas, the gas comprising at least 90% nitrogen.

2. The detecting device according to claim 1, wherein the gas is pure N₂.

3. The detecting device according to claim 1, wherein the gas contains between 95% and 100% N₂ and between 0% and 5% hydrocarbon.

4. The detecting device according to claim 3, wherein the hydrocarbon has fewer than 10 carbon atoms.

5. The detecting device according to claim 4, wherein the hydrocarbon is ethane.

6. The detecting device according to claim 1, wherein the gas is at a pressure in the enclosure equal to or higher than 500 mbar.

7. The detecting device according to claim 1, wherein the second electrode has a diameter lower than 1 cm.

8. The detecting device according to claim 7, wherein the diameter is lower than 5 mm.

9. The detecting device according to claim 1, wherein the first electrode has a diameter higher than 10 cm.

10. A method comprising detecting neutrons the energy of which is lower than 100 meV with the detecting device according to claim 1.

11. A method comprising detecting neutrons the energy of which is between 1 MeV and 20 MeV with the detecting device according to claim 1.
